(19) United States
(12) Patent Application Publication
(10) Pub. No.: US 2010/0326361 A1
(43) Pub. Date: Dec. 30, 2010

(54) MILKING DEVICE

(75) Inventors: Karel VAN DEN BERG, BLESKENSGRAAF (NL); Frank Gerard REGELINK, DEN HAAG (NL)

Correspondence Address: HOWREY LLP-EU, C/O IP DOCKETING DEPARTMENT, 1299 Pennsylvania Avenue, NW, Room B-3, Washington, DC, 20004-2402, US

(73) Assignee: LELY PATENT N.V., MAASSLUIS (NL)

(21) Appl. No.: 12/875,204

(22) Filed: Sep. 3, 2010

Related U.S. Application Data
(63) Continuation of application No. PCT/NL2009/000046, filed on Feb. 26, 2009.

(30) Foreign Application Priority Data
Mar. 4, 2008 (NL) 1035117

(51) Int. Cl. A01J 5/16

(52) U.S. Cl. 119/14.47; 119/14.51

(57) ABSTRACT

The present invention provides a milking device including a carrier with a holder for at least one milking cup, the milking cup being connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein an upper section of the milking cup is provided with an opening for receiving a teat, wherein the milking cup, in a bottom section, engages with the hauling-in member at a first location, and wherein the bottom section is formed by an end body having a downwardly projecting contact part, a bottom end which extends next to and below the first location.

### CROSS REFERENCE TO RELATED APPLICATIONS

This application is a continuation of PCT application number PCT/NL2009/000046 filed on Feb. 26, 2009, and claims priority from Netherlands application number 1035117 filed on Mar. 4, 2008, the contents of which are hereby incorporated by reference in their entirety.

### BACKGROUND OF THE INVENTION

1. Field of the Invention

The invention relates to a device for use in a milking process, in particular for automatic milking.

The invention relates in particular to a milking device comprising a frame and a carrier supported by the frame and comprising a holder assembly for a (milking or teat) cup, wherein the cup is connected to a dedicated discharge line for liquid from the cup, such as cleaning agent, rinsing agent, premilk, milk, and the holder assembly is provided with a holder for supporting the cup. By means of an elongate, flexible hauling-in member, such as a cord, or the milking hose itself, the cup is furthermore connected to the frame, in particular to a hauling-in means, such as a winch or a cylinder, which is attached thereto. By operating the winch, the cups can be hauled in after use, such as after milking, when they have been released from the teats of the animal to be milked, such as a cow, and be placed in the respective holder. It should be noted that in the context of the present application, the terms milking device, milking cup, milk discharge line are understood to mean a device, cup and discharge line which are intended for and/or used in one or more of the operations performed during the milking process, including precleaning the teats, premilking, milking and final cleaning of the teats.

2. Description of the Related Art

In a conventional milking device, the holders are provided in a block at the end of a carrier arm. Each holder is provided with an exact conical receiving space for accommodating the complementary conical bottom end of the milking cup. A hauling-in cord is fixed to the central tip at the bottom end of the milking cup and extends through a hole in the tip of the receiving space, through the arm-shaped carrier to a hauling-in cylinder. In the upward direction, the conical bottom end of the milking cup adjoins a straight circular cylindrical sleeve, in which the cup lining is accommodated and a milking connection and an air hole which is connected to the discharge line.

In the block, the carrier for each holder is furthermore provided with a cylinder for tilting the holder in order to tilt the respective milking cup from an obliquely backwardly tilted rest position, in which cleaning may, if desired, take place, to a vertical or forwardly tilted standby or fitting position.

By hauling in the cord, the milking cup is taken to the holder. However, it is possible that the conical tip of the milking cup hits the outer side, in particular bottom side, of the holder in such a manner that movement of the latter is blocked. It is then necessary to give the milking cup a push by hand or take it by hand and place it in the holder.

In particular if the milking cup is situated next to the carrier arm on the floor, hauling in may be rendered more difficult by the fact that the hauling-in cord slides along the carrier arm, as a result of which the milking cup is placed on the seating incorrectly. It is also possible that the hauling-in cord becomes trapped. Furthermore, the milk discharge line may hamper correct introduction of the milking cup in the holder as a result of premature contact with the carrier arm.

After milking has finished and the underpressure in the milking cup is cancelled, the respective milking cup falls away from the teat, possibly on the ground. In this case, the air hole may become soiled. The cord then extends downwards from the holder.

The height of the teats to which the milking cups are to be attached may vary. If the teats are relatively low, the space between the teats and the floor may be too small to manoeuvre the carrier arm with the block of holders in a sufficiently controlled manner.

### BRIEF SUMMARY OF THE INVENTION

It is an object of the invention to provide a milking device, in which the milking cup can be introduced into the holder in a reliable manner.

It is an object of the invention to provide a milking device, in which the milking cup and holder assembly, the milking cup and/or holder for the milking cup can be compact in the vertical sense.

It is an object of the invention to provide a milking device, in which the cup can be moved in a simple manner between a standby position and a storage position.

It is an object of the invention to provide a milking device, in which the discharge line connected to the cup may be protected.

A milking device according to various aspects of the invention comprises a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein an upper section of the milking cup is provided with an opening for receiving a teat, characterized in that the milking cup, in a bottom section, engages with the hauling-in member at a first location, wherein the bottom section is formed by an end body having a downwardly projecting contact part, a bottom end of which extends next to and below the first location. When the milking cup is hauled in using the hauling-in member, such as a cord, which usually enters the milking cup at the location of a hole on the cup axis, the first contact with the holder will usually be with the contact part projecting parallel to the cord. Further pulling on the cord results in a moment being exerted on the milking cup, which is consequently able to carry out a tilting movement about the area of contact. A stable situation of contact is thus prevented, so that the milking cup does not become stuck against the outside of the holder.

The tilting movement is improved if the contact part is rounded and pointed.

In one embodiment, the contact part is eccentric with respect to the cup axis.

The first location may, as is known per se, coincide with the cup axis.

In one embodiment, in which the hauling-in member is separate from the discharge line, for example a cord, the contact part provides room for a connection for the discharge line, preferably situated on the same side of the cup axis as the bottom end of the contact part, preferably coinciding with the bottom end in the same radial plane which contains the cup axis.

The instability may be increased if the end body in the end section thereof which comprises the contact part is shaped asymmetrically, viewed in a first side view, with respect to the cup axis. The asymmetrical shape, which results in a preferred orientation, can also serve to orientate the milking cup on the seating correctly.

In one embodiment, the bottom end of the contact part is situated on the peripheral edge of the milking cup, viewed in a plane of projection at right angles to the cup axis. This also makes it possible to provide space in the end body for accommodating a connection for the discharge line which is situated on the peripheral edge.

In one embodiment, the milking cup, as is known per se, comprises a cylinder sleeve between the upper and the lower section of the milking cup. In this case, the end body may have a side surface which is substantially in line with the sleeve and to which the connection leads.

In one approach, the contact part has a non-round cross section along planes at right angles to the cup axis. This assists in directing the milking cup while it is being placed on the seating. If the contact part is provided with a connection for the discharge line, the non-round cross section may be symmetrical with respect to a first plane which comprises the cup axis and an axis of the connection and asymmetrical with respect to a second plane which comprises the cup axis and is at right angles to the first plane.

The contact part may comprise a substantially oblique conical section, in which the top of the oblique conical shape forms the bottom end of the contact part.

The instability upon contact can be improved if the contact part forms an edge which intersects the cup axis at an angle. The edge may, viewed in a plane which contains the cup axis and the edge, be convex, as a result of which the tilting movement can be started smoothly. On either side of the edge, bottom surfaces may be formed which are inclined from the edge and which preferably extend up to the periphery of the milking cup. After tilting with these surfaces, the milking cup can come into contact with the outer side of the holder and thus perform a sliding movement when pulling on the hauling-in member is continued.

At a second location, the contact part may be provided with an air hole which is connected to the discharge line, wherein the second location is situated at a distance from the peripheral edge of the end body. As a result thereof, it is possible to prevent dirt from entering into the air hole and impeding the pulsating movement of the lining in the milking cup when the milking cup is flat on the floor. In the abovementioned embodiment with inclined surfaces, the air hole can be provided therein.

In another embodiment, the invention thus also provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the lower section of the milking cup is provided with an air hole which is connected to the discharge line, wherein the air hole is situated on a surface which is inclined with respect to the cup axis.

In yet another embodiment of the present invention, the invention thus also provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the milking cup comprises a cylindrical sleeve for surrounding a milking lining, wherein the upper section of the milking cup is provided with an opening for receiving a teat and wherein the lower section of the milking cup is provided with an air hole which is connected to the discharge line, wherein the air hole is situated in a location which is set back radially with respect to the sleeve.

As mentioned above, the contact part may be provided with a connection for the discharge line. The latter in turn has a connection axis, in which the connection axis and the bottom end of the contact part and the cup axis may be in one plane. The connection and the bottom end of the contact part may be situated on the same side of the cup axis. This makes it possible to reduce the construction height of the milking cup.

In yet a further embodiment of the present invention, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the upper section of the milking cup is provided with an opening for receiving a teat, wherein the lower section of the milking cup, viewed in a side view, is shaped asymmetrically with respect to the cup axis, wherein the seating has a reference line which coincides with the cup axis when the milking cup rests on the seating and the seating of the holder is delimited by a seating wall, which is shaped asymmetrically on the inner side, viewed along a cross-sectional plane parallel to the plane of side view, with respect to the reference line for fittingly accommodating the contact part of the end body. Thus, as has already been mentioned above, the asymmetrical shape is also used for correctly positioning the milking cup in the holder.

According to yet a further embodiment, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the seating wall has an upper edge with a recessed passage for the hauling-in member. This results in the hauling-in member, such as a cord, being forced into a known position. The milking cup is in this case taken to a fixed hauling-in spot near the holder. The shape of the holder can then, in a relatively simple manner, be adapted to the positions and orientations of the milking cup to be expected during contact with the holder.

In one embodiment thereof, the seating has a reference line which coincides with the cup axis when the milking cup rests in the seating, wherein the upper edge has first edge sections which are inclined towards one another with respect to a reference plane which is at right angles to the reference line towards a lowered second edge section which contains the passage. The guiding of the hauling-in member along the edge to the inside and also to the second edge section is improved if the first and second edge sections are convex in cross section.

In a further development thereof, the holder is situated on the end of a carrier arm of the carrier, which carrier arm has a main direction, wherein the seating wall has seating side walls and a distal end wall connecting these side walls to one another, wherein the first and second edge sections of the upper edge of the seating wall are situated in the end wall, wherein the second edge section is preferably situated in the centre thereof. The milking cup will then always be hauled in at the end of the carrier arm with holder, even if the milking cup is, for example, next to or under the carrier arm at the start of the hauling-in process. This is even more so the case if the seating side walls form third edge sections which adjoin the second edge sections and run in a distal direction.

According to a further aspect, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the seating has a seating wall with a bottom wall, which is provided with a passage for the hauling-in member, wherein the seating wall has a seating side wall with an upper edge having a section which has a smallest distance to the passage compared to the adjoining sections of the upper edge on either side, which section preferably intersects a vertical centre plane of the holder.

The guiding of the hauling-in member is improved if, viewed in projection on the reference plane, the distal end wall is essentially U-shaped or V-shaped. The top of the U shape or V shape may be convex.

The seating wall may be interrupted in the proximal direction in order to form a passage for the discharge line. The discharge line can then remain in a low position, for example in the above-described case of a low connection to the milking cup. If the carrier arm in this case forms a duct adjoining the passage, the discharge line can also retain its low position in the subsequent section, as a result of which the required space in the vertical sense is limited, and incidentally the discharge line is to some degree protected.

According to a further aspect, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the seating has an inner surface with a hole for the passage of the hauling-in member, wherein the inner surface comprises a section which is situated lower than the hole.

According to a further aspect, the invention thus provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the seating of the holder is delimited by a seating wall, which is interrupted in one direction, preferably in a direction towards the carrier, for forming a passage for the discharge line. The hauling-in movement of the discharge line is improved if the seating is delimited in the horizontal direction only towards two opposite lateral directions and in a direction transversely thereto, away from the carrier.

A movement of the hauling-in member and of the milking cup after contact with the cup holder is improved if the outer surface of the end wall, viewed in a cross-sectional plane at right angles to the reference plane, is convex. This is also the case if the seating wall has a bottom wall which, viewed in a cross-sectional plane transversely to the main direction, forms a preferably convex outer surface which is inclined towards a lowest point, and/or, viewed in a cross-sectional plane parallel to the main direction and transversely to the reference plane, forms a preferably convex outer surface which is inclined towards a lowest point.

Hauling in the milking cup is improved if the seating wall has a bottom wall, which is provided with a passage for the hauling-in member. In order to guide the hauling-in member, a duct may be provided in the bottom wall and/or the seating side wall for guiding the hauling-in member from the passage to a proximal location. In this context, proximal is understood to mean that side which is turned towards the frame of the milking device, the hauling-in side, opposite to the distal side.

In a further embodiment, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the carrier comprises a carrier arm, on the distal end of which the holder is arranged, wherein the carrier arm extends along a main direction, wherein the holder is connected to the carrier arm by means of a single pivot and is rotatable about the pivot axis thereof in an upward and proximal direction from a receiving position in which the milking cup is vertical in the standby position to a storage position in which the cup axis extends essentially parallel to the main direction. In this way, a milking cup is brought into a protected position, in which the construction length is limited, in a simple manner.

According to yet a further embodiment, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the carrier comprises a carrier arm, on the distal end of which the holder is arranged, wherein the carrier arm extends along a main direction, wherein the holder is connected to the carrier arm by means of a single pivot and is rotatable about the pivot axis thereof in an upward and proximal direction from a receiving position in which the milking cup is vertical in the standby position to a storage position tilted in the proximal direction, wherein the single pivot is situated on the proximal end of the holder.

In this way, a milking cup is brought into a protected position in a simple manner, in which the construction length is limited. The holder itself may in this case have a low construction height.

Preferably, when the milking cup is accommodated in the holder in the standby position, it extends below a horizontal plane which contains the pivot axis.

According to a further embodiment, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the carrier comprises a carrier arm, on the distal end of which the holder is arranged, wherein the carrier arm extends along a main direction, wherein the holder is connected to the carrier arm by means of a pivot which is located on the proximal side of the milking cup and is rotatable about the pivot axis thereof in an upward and proximal direction from a receiving position in which the milking cup is vertical in the standby position to a storage position, in which the cup axis is at an angle to the main direction of less than 45 degrees, preferably extends substantially parallel to the main direction.

According to a further aspect, the invention thus also provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the carrier comprises a carrier arm, on the distal end of which the holder is arranged, wherein the carrier arm extends along a main direction, wherein the holder is rotatable with respect to the carrier arm in a vertical plane about a pivot axis by means of a pivot, preferably from a position in which the milking cup is kept in a vertical standby position in an upward and proximal direction, wherein the milking cup extends, in the standby position in which it is accommodated in the holder, to below a horizontal plane which contains the pivot axis. As a result thereof, the construction height can be limited, as can the space requirement for rotating the holder with milking cup.

In a further development thereof, wherein the lower section of the milking cup is provided with a lateral connection for the discharge line, the shape of the seating of the holder and the lower section of the milking cup are adapted to one another in order to ensure that the connection is situated at least substantially below the pivot axis in the standby position of the milking cup.

In another embodiment, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the carrier comprises a carrier arm, on the distal end of which the holder is arranged, wherein the holder is connected to the carrier arm by means of a pivot and is rotatable about the pivot axis thereof between a milking cup-receiving position of the holder and a storage position, wherein the holder and the carrier arm form a duct for the discharge line, wherein the duct is delimited by side walls, wherein the pivot is formed in both side walls by side wall sections which form partial pivots, the pivot axes of which are in line with one another. Such an arrangement for the pivot requires little space. The pivot in this case leaves space for other parts, such as the discharge line. This also facilitates a lower position of the milking cup with respect to the pivot axis. The duct may have an at least partially open bottom.

In one embodiment thereof, each partial pivot in the respective side wall comprises a central pivot plate part with a circular edge section, as well as a cavity with a bearing edge therefor which is of complementary shape. With such an arrangement, the forces in the pivot can be distributed across a relatively large surface area.

The articulation of the pivot movement can be improved if the bearing edge is formed on a circularly curved strip, and the edge section of the pivot plate part forms the radial inner edge of a circular guide groove for the strip.

The central pivot plate parts may be integrally formed with the holder.

In a further embodiment, the hauling-in member is connected to a drive mechanism for exerting a tensile force on the hauling-in member for rotating the holder about the pivot axis in order to bring the milking cup from the standby position into said storage position. One (hauling-in) member, which is already present anyway in order to haul in the milking cup, can also be used to achieve the rotation, as a result of which the arrangement can be kept simple.

According to a further aspect, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the milking cup and the holder, respectively, are provided with first and second aligning means interacting with one another for aligning the orientation of the milking cup with respect to its cup axis, that is to say at an angle viewed in a plane at right angles to the cup axis.

In one embodiment thereof, the bottom end of the milking cup is formed asymmetrically, viewed in a side view, with respect to the cup axis in order to form the first aligning means, wherein the seating has a reference line which coincides with the cup axis when the milking cup rests in the seating, and the seating of the holder is delimited by a seating wall, which is formed asymmetrically on the inner side, viewed along a cross-sectional plane parallel to the plane of the side view, with respect to the reference line for fittingly accommodating and uniquely orientating the contact part with respect to the cup axis of the contact part of the end body in order to form the second aligning means. The milking cup can only be positioned in the seating in one direction, viewed in a plane at right angles to the cup axis.

According to a further aspect, the invention provides a milking device comprising a carrier with a holder for at least one cup, in particular a milking cup, which is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein the milking cup is provided with a through-passage for the hauling-in member, which passage has a first end and a second end, wherein the hauling-in member enters the passage at the first end and is fixed in the second end. For replacement, the hauling-in member can then be detached in a simple manner at the second end which may also be situated in the end body, if desired in the contact part. The hauling-in member may be fixed in the hauling-in direction in the second end of the passage and be free in the opposite direction, for example by folding it onto itself in the second end of the passage.

In one embodiment, the abovementioned carrier which is provided with the holder can be moved between a retracted position and an extended position for fitting the milking cup(s) on the cow, optionally using an auxiliary means, such as a gripper.

Alternatively, the abovementioned carrier may be stationary and present the milking cup(s) to an installation means, such as a gripper.

According to a further aspect, the invention provides a milking cup which is clearly suitable and intended for a milking device according to the invention.

According to a further aspect, the invention provides a milking installation comprising a number of milking devices according to the invention.

The aspects and measures described in the present description and claims of the application and/or illustrated in the drawings of the present application, such as the eccentric shape of the bottom end of the cup, the eccentric shape of the seating for the cup, the recessed air hole at the bottom end of the milking cup, the embodiment of the upper edge of the seating with a preferred position for the hauling-in member, the open construction of the arm and seating for forming a trough, the position and the embodiment of the pivot connection of the holder with the rest of the arm, the attachment of the hauling-in member to the cup and other aspects may, where possible, also be used separately from one another.

### BRIEF DESCRIPTION OF THE DRAWINGS

The features and advantages of the invention will be appreciated upon reference to the following drawings, in which:

FIG. 1 shows a side view of an arrangement for automatic milking of a cow, provided with an exemplary embodiment of a milking device according to the invention;

FIGS. 2A and 2B show two side views of an exemplary embodiment of a milking cup for a milking device according to the invention, along directions which are at right angles to one another;

FIGS. 3A-3E, respectively, show side views from opposite sides, a front view, a bottom view and a top view of an exemplary embodiment of a holder for a milking device according to the invention;

FIGS. 4A-D, respectively, show a side view, a top view and two vertical longitudinal sections of a carrier with the holder from FIGS. 3A-E;

FIGS. 5A-O show a number of successive stages during hauling-in of the milking cup from FIGS. 2A and 2B onto the holder from FIGS. 3A-E;

FIGS. 6A-C show a number of successive stages during conveying of the milking cup and holder from the preceding figures from a standby position to a storage position according to the present invention.

### DESCRIPTION OF ILLUSTRATIVE EMBODIMENTS

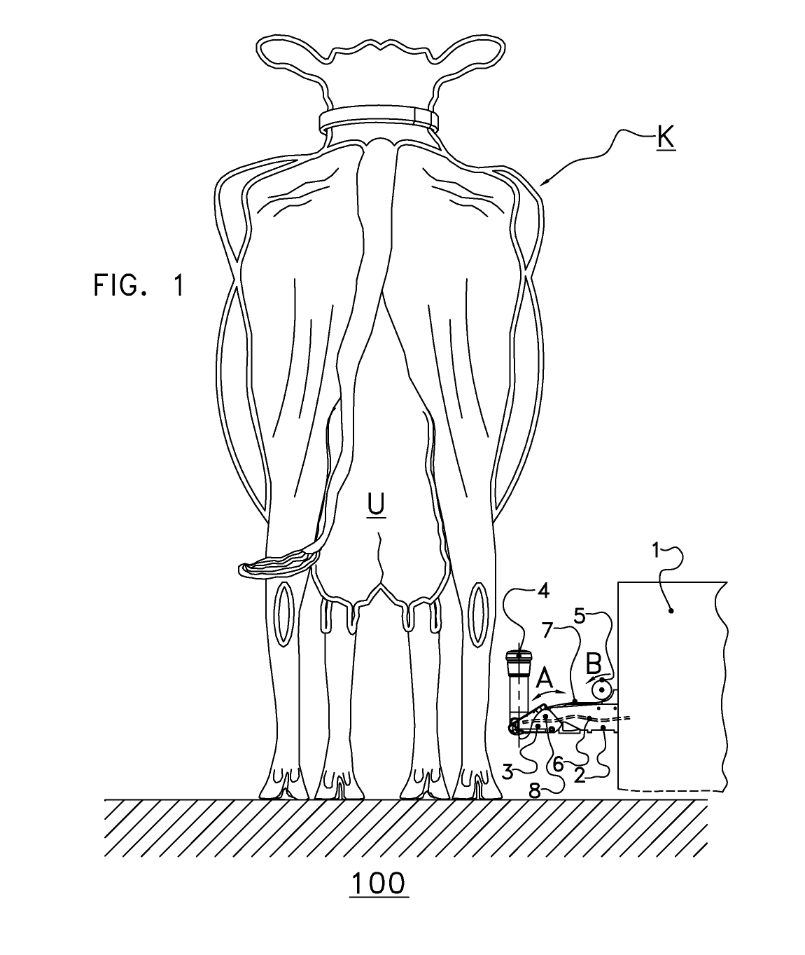

The following is a description of certain embodiments of the invention, given by way of example only and with reference to the drawings. FIG. 1 shows an arrangement for automatically milking a cow K having udders U and teats, which is standing on a floor 100. From the side, from a diagrammatically indicated frame 1, extends a robot arm 2 which can be operated from and by the frame, which arm carries a holder 3 at its distal end which is rotatable with respect to the arm 2 by means of a pivot connection 8 in the direction A between the illustrated position, in which a milking cup 4 is held on standby, and a storage position in which the holder 3 is tilted away upward and to the left, viewed in the plane of the drawing. From the milking cup 4, a milk discharge line 6 extends in the proximal direction to a storage container (not illustrated in any more detail). From the milking cup 4, a cord 7 runs in the proximal direction to a reel 5 on the arm, which reel can be driven by a motor (not illustrated) in the direction B for hauling in the cord 7.

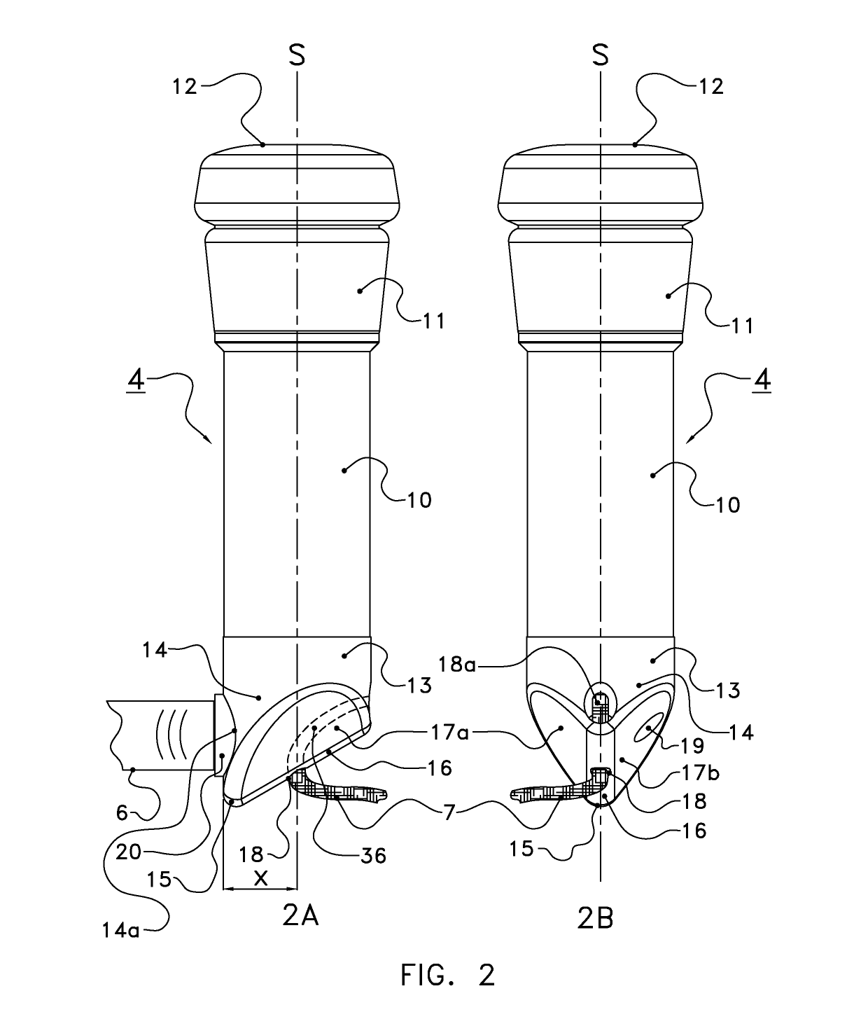

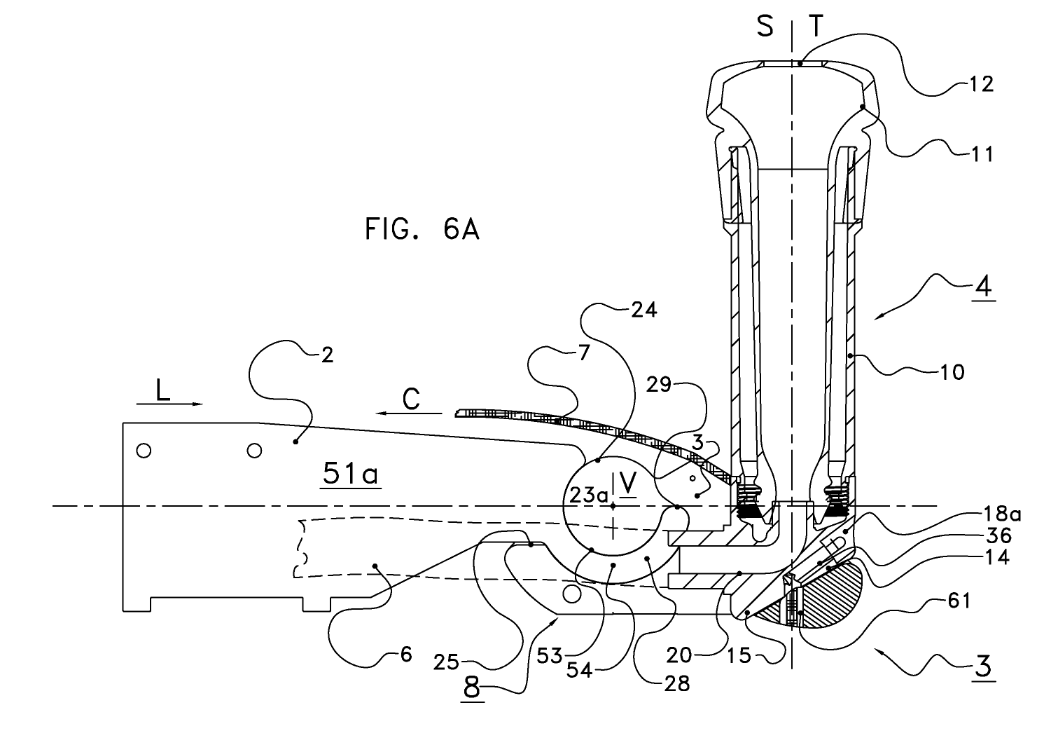

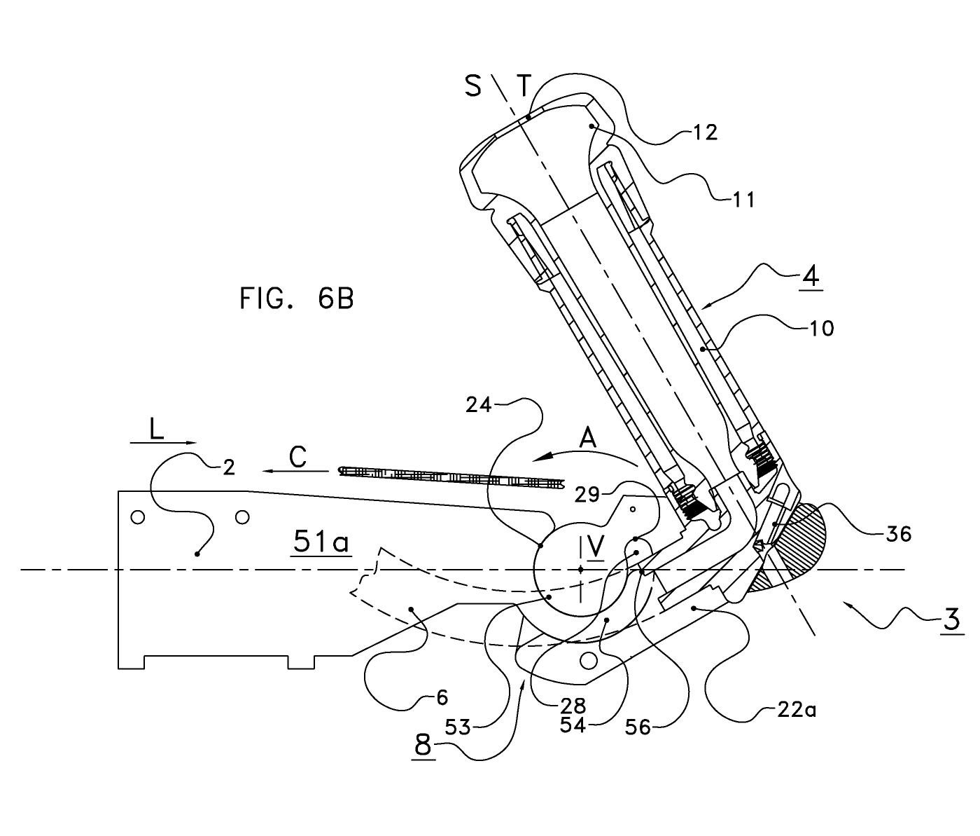

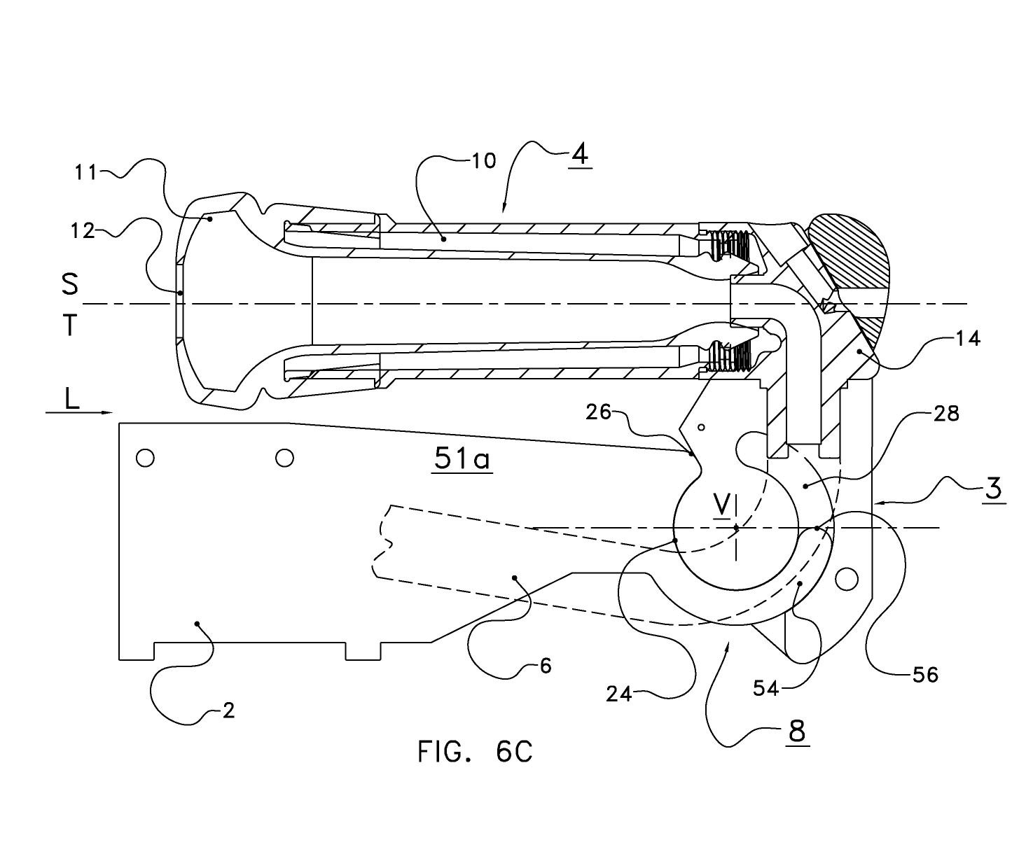

The milking cup 4 from FIGS. 2A and 2B comprises a cup axis S and a straight circular cylindrical sleeve 10 which relates thereto and has an upper section 11 with an access hole 12 for a teat. The sleeve 10 surrounds a lining (not illustrated) in the usual manner. The bottom section of the milking cup 4 is formed by an end body 13, which comprises a straight circular cylindrical section 13a and a contact part 14 which differs in shape from a rotating body. The end body may be a separate part of the milking cup 4 or be integrally formed with the sleeve thereof. In the illustrated example, the surface of section 13a is in line with the surface of sleeve 10, but there may also be a transition edge. The cord 7 engages with the milking cup 4 in a hole 18 which is on the axis S. The cord is fastened to the milking cup 4 in such a manner that it cannot be pulled out. In this example, the cord 7 extends through a passage 36 in the contact part 14 to opening 18a, in which the cord end as such is folded up and, if desired, fixed in said position using, for example, a tie-wrap, in an enlarged end of the passage 36 near opening 18a. The folded-up end forms a kind of anchor against displacement in the direction towards hole 18, see also FIG. 6A. The folded-up end may alternatively or in this case be fixed in the enlarged end by clamping. However, in both cases displacement in opposite directions is possible if the user takes hold of the folded-up cord end. By folding the cord end out again, the cord end can then be pulled through the passage, for example in order to replace said cord by a new cord. In this case, the user does not require any tools.

In the view from FIG. 2A, the contact part 14 is triangular and asymmetrical with respect to the axis S. The contact part 14 forms a central edge 16, which ends in a rounded end 15, which adjoins side surface 14a of contact part 14, which side surface is in line with the side surface of section 13a. The edge 16 forms the boundary between two oblique end faces 17, which, as is shown in FIG. 2B, are situated mirror-symmetrically with respect to the edge 16. In one of the side faces 17, an air hole 19 is provided which forms an air connection between the environment and the milk discharge line in order to improve the flow of milk. The end 15 is at a distance x from the axis S.

On the side surface 14a, the milking cup 4, in the contact part 14 which is eccentric with respect to the cup axis S, is provided with a passage 20 for connecting the milk discharge line 6. By accommodating the connection 20 in the section of the milking cup which is formed so as to be accommodated in the seating of the holder, the height of the milking cup can still be limited, and consequently the height of the assembly of holder and milking cup. In addition, the contact part 14 offers space for an internal bend section for the discharge of milk between the lining of the milking cup and the connection 20, so that the discharge of milk is improved.

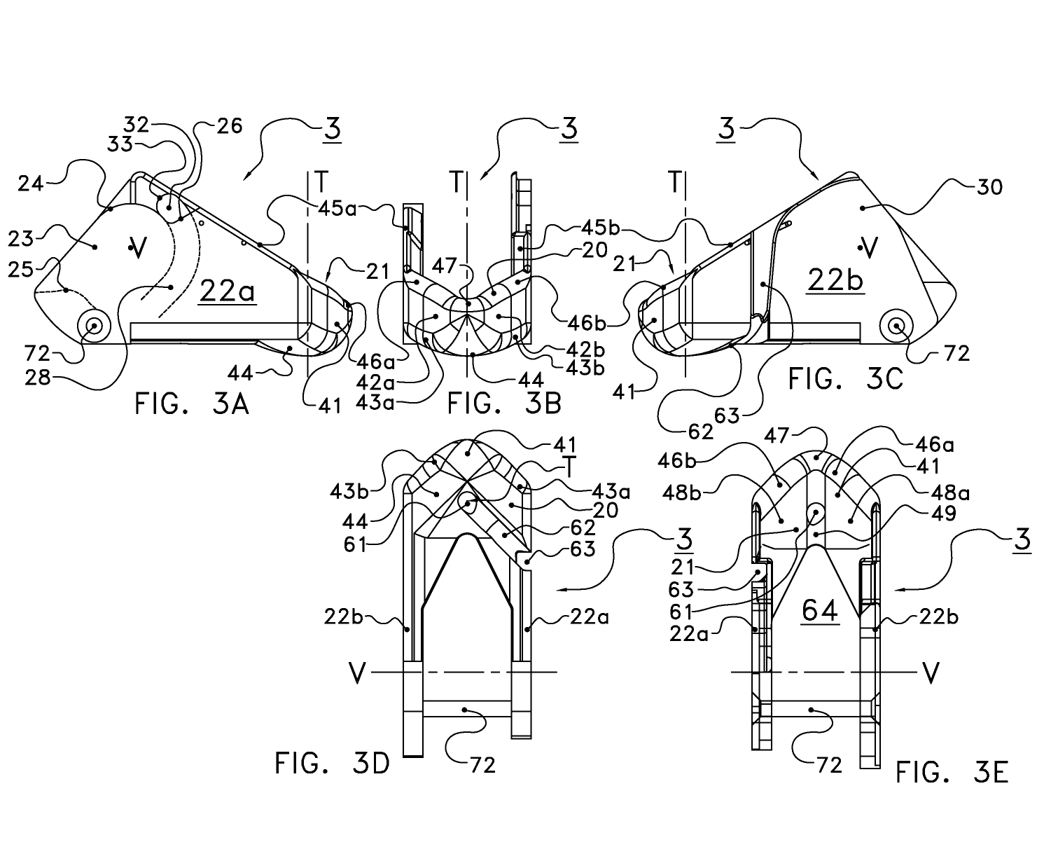

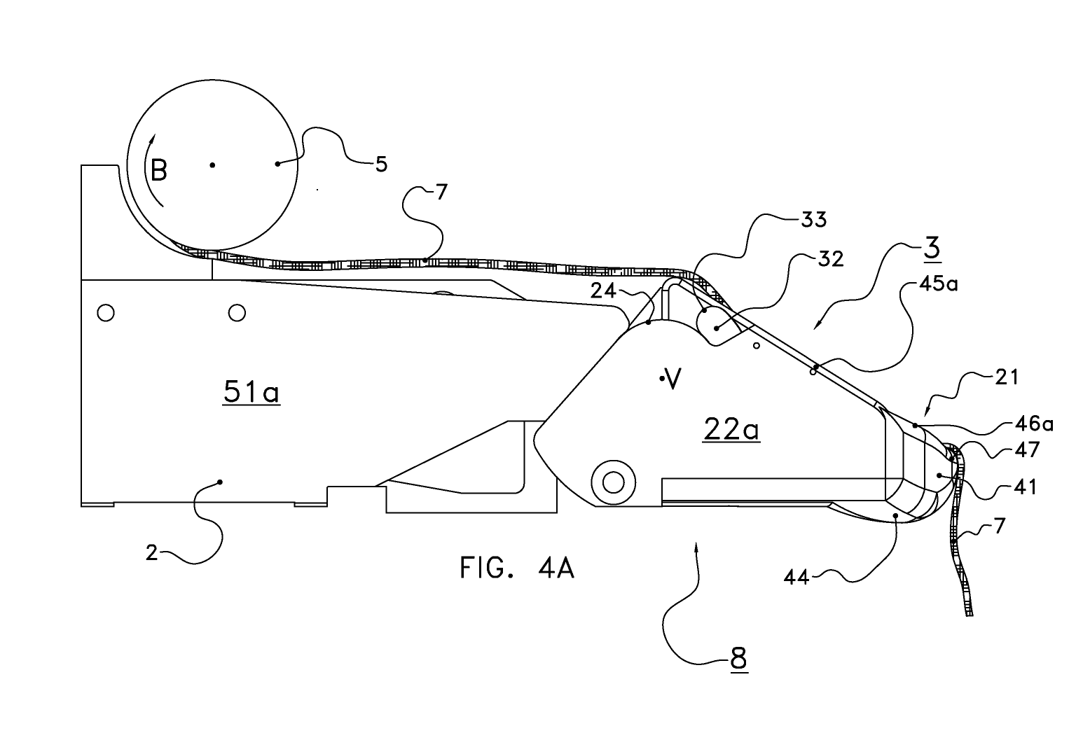

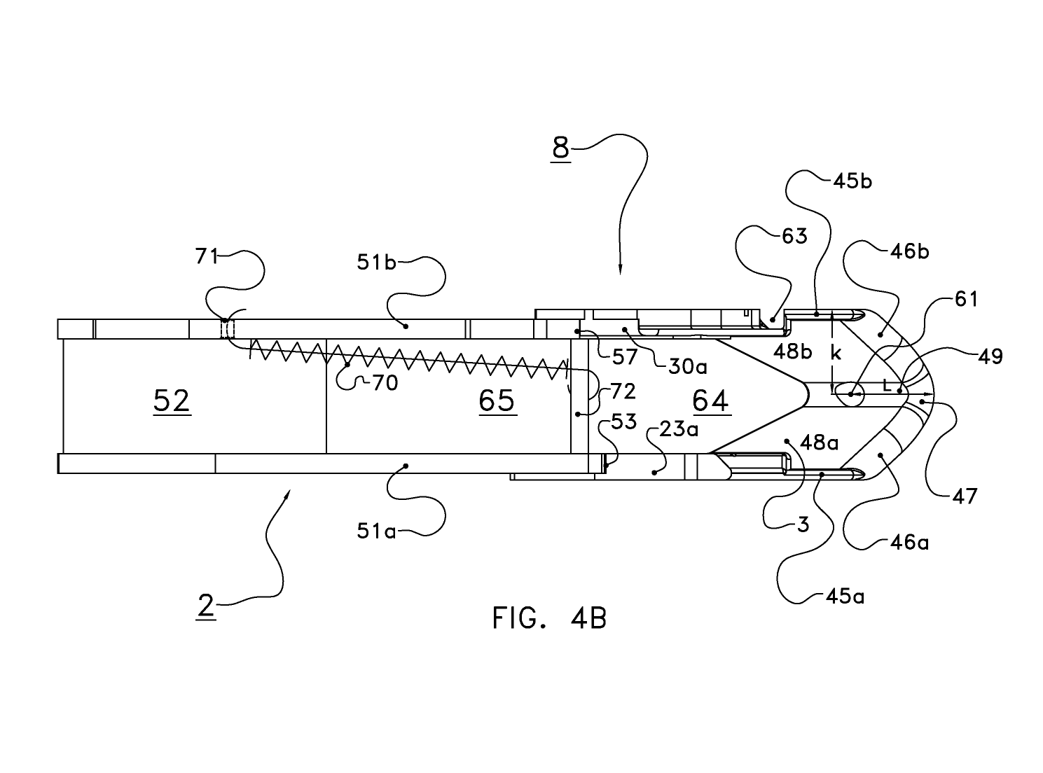

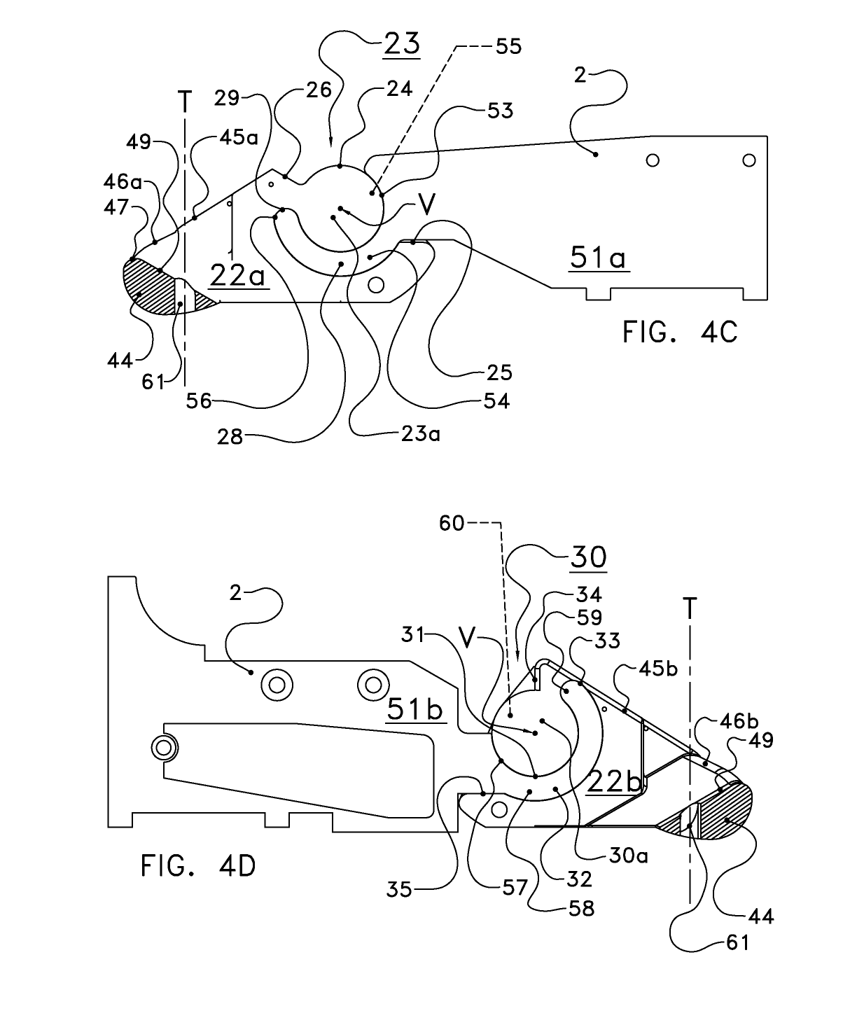

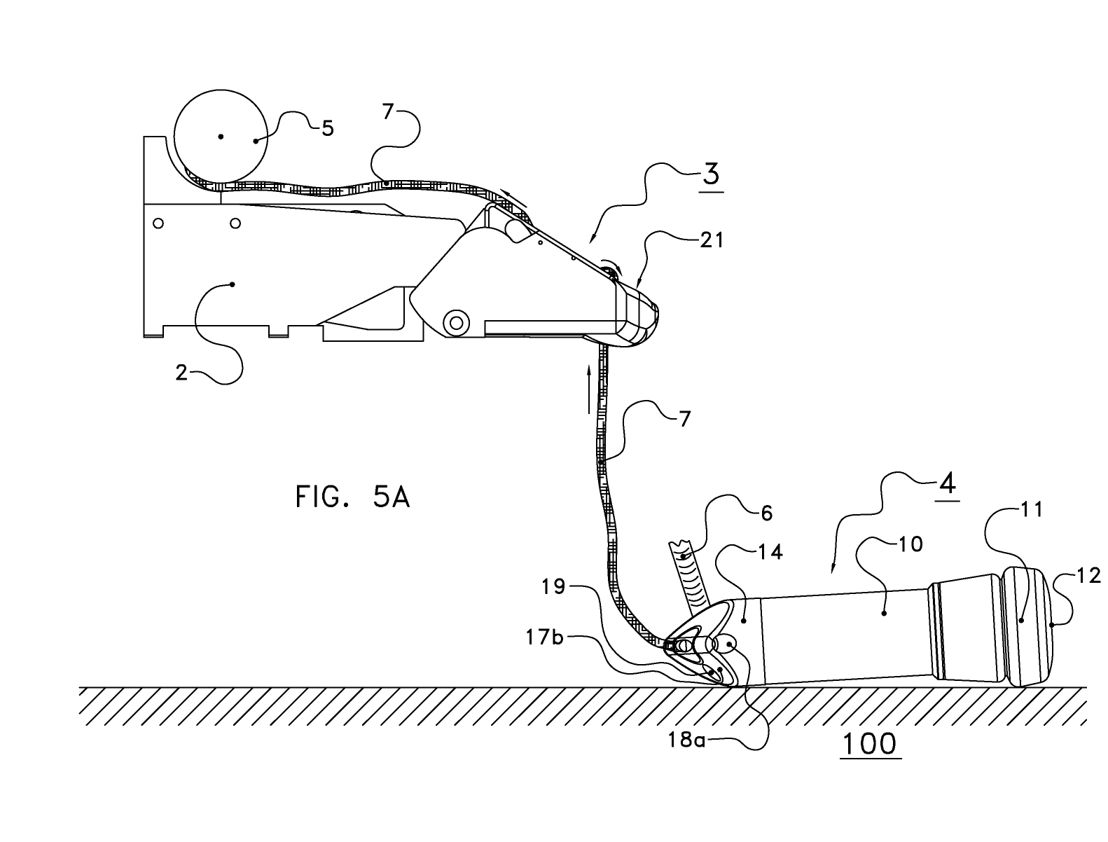

The holder 3 with adjoining section 2a of the arm 2 illustrated in FIGS. 3A-E and FIGS. 4A-D forms a seating 21 for the milking cup 4 at the distal end of the arm 2, wherein the seating 21 has an axis T which coincides with the cup axis S when the milking cup 4 rests on the seating 21. The holder 3 comprises two side walls 22a, 22b and a bottom wall 40, as well as a front wall 41. On the proximal side, the side walls 22a, 22b merge into pivot plates 23, 30, wherein the inner side of pivot plate 23 is provided with a circular groove 28 with inner end 29, which groove merges into an end stop 25 at the open end. The inner plate 23 has a circular edge 24, which ends in end stop 26. The groove 28 and the edge 24 delimit a circular inner plate part 23a. In a similar manner, the side wall 22b in the pivot plate 30 is provided with a circular edge 31 with a stop 34 and, at a radial distance therefrom, with a circular groove 32 with an end 33, which groove merges into an end stop 35 at the open end. The groove 32 and the edge 31 delimit a circular inner plate part 30a.

The adjoining section 2a of the arm 2 is essentially trough-shaped or duct-shaped, with side walls 51a,51b and a bottom 52, which may largely be open, see open section 65. Near the bottom 52, a hole 71 is provided in the side wall 51b for attaching the end of a spring 70 by hooking in. On the holder side, the side wall 51a forms a concave circular edge 53 and a circular strip 54 with an end 56, which together define a receiving space 55 for fittingly accommodating inner plate part 23a of the holder side wall 22a. In a similar manner, the side wall 51b forms a concave edge 57 and a circular strip 58 with an end 59, which together define a receiving space 60 for fittingly accommodating inner plate part 30a of the holder side wall 22b.

In the illustrated receiving position of the holder 3, the axis T of the seating is at right angles to the longitudinal direction L of the arm 2. The abovementioned circular paths are all concentric with respect to the same pivot axis V for single pivot 8 for the holder 3. The pivot axis V is at right angles to the longitudinal direction L and the axis T, see also FIG. 4A.

Near the bottom, the holder 3 is provided with a transverse pin 72 for the other end of the spring 70. The spring 70 extends below the pivot axis V, so that the holder 3 is prestressed into the illustrated receiving position, in which the ends 56, 59 of the strips 54, 58 support the ends 29, 33 of the grooves 28, 32 and the stop 25 rests against a stop 69 on side wall 51a.

On the distal side of the pivot 8, the side walls 22a, 22b are provided with upper edges 45a, 45b which run straight in the distal direction and merge into upper edges 46a, 46b of front wall 41. The upper edges 46a, 46b are convex in cross section. They end in a recess 47. The top view of FIG. 3E shows that the front wall 41 is V-shaped, with the recess 47 being situated in the tip, in a vertical surface which contains the arm longitudinal axis L. FIG. 3E also shows that the seating 50 is delimited on the distal side by surfaces 48a, 48b, which are inclined inwards from the upper edges 46a, 46b. The surfaces 48a, 48b are inclined towards a hole 61 in the bottom 40 for the cord 7 and meet in a line 49 which is situated in a vertical plane which contains the longitudinal direction L. The hole 61 is concentric with respect to seating axis T. The inclination of the surfaces 48a, 48b with respect to axis T corresponds to that of the surfaces 17a, 17b and the edge 16 with respect to the cup axis S. The surfaces 48a, 48b continue on the proximal side of the hole 61, and end in recess 64 of the bottom 41. On the proximal side, the seating 50 is thus open in the horizontal direction with respect to the rest of the arm 2, so that it links with the trough-shaped space of the arm 2, see FIG. 4B. The distance between the upper edge of the seating wall and the hole 61 is smallest at the location of the recess 47, as is diagrammatically illustrated in FIG. 4B, in which “k” denotes the distance of a spot on the upper edge 45b to the hole 61 and “l” denotes the distance from recess 47 to the hole 61.

In the outer surface of the bottom 40, a groove 62 is formed which extends obliquely in the proximal and lateral direction. The groove 62 adjoins an upward groove 63, which is provided in the outer surface of side wall 22b. The hole 61 and the grooves 62, 63 serve as a passage and guide for the cord 7. The upper end of the groove 63 is considerably above the level of the pivot axis V. In the position of use, the cord 7 will extend horizontally away from it toward the reel 5, so that a tensile force exerted by the reel 5 on the cord 7 exerts an upward torque on the holder 3.

The outer surface 44 of the bottom 40 is formed so as to be inclined towards the centre of the bulge in two vertical cross sections which are at right angles to one another, in this case in a convex manner. The bottom 40 becomes thinner on the proximal side, and ends in a recess 64, which adjoins the opening 65 in the bottom 52 of arm 2, see FIG. 4B. This provides more freedom of movement for the milk discharge hose. On the distal side, the bottom 40 merges in a smoothly curved manner into the rounded tip of the front wall 41.

The outer surface of the side walls 22a, 22b is flat. The outer surface of the front wall 41 is slightly flat below the upper edges 46a, 46b (vertical surfaces 42a, 42b), so that it merges into the bottom surface 44 via convex surfaces 43a, 43b.

As only the groove 62 has to be provided in the bottom 40, but the groove 62 can be provided in material which forms the inclined outer surface, the thickness thereof can be limited. This is a further way of limiting the height of the assembly of milking cup and holder.

In use, in the situation in FIG. 1, the holder 3 with the milking cup 4 is positioned under the udders U and a teat T by operation of the arm 2. As a result of the low construction height of the end of the arm 2, in particular the assembly of holder 3 and milking cup 4, this operation can also be carried out in a reliable manner in the case of animals where the free space under the teats is much smaller.

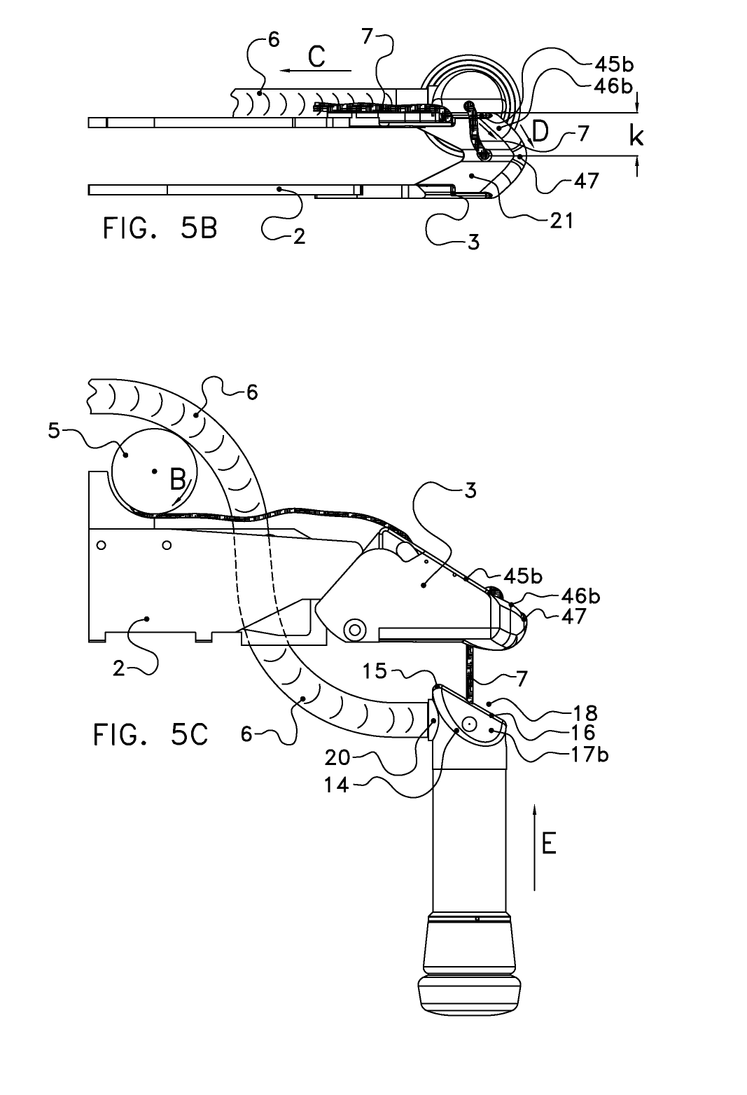

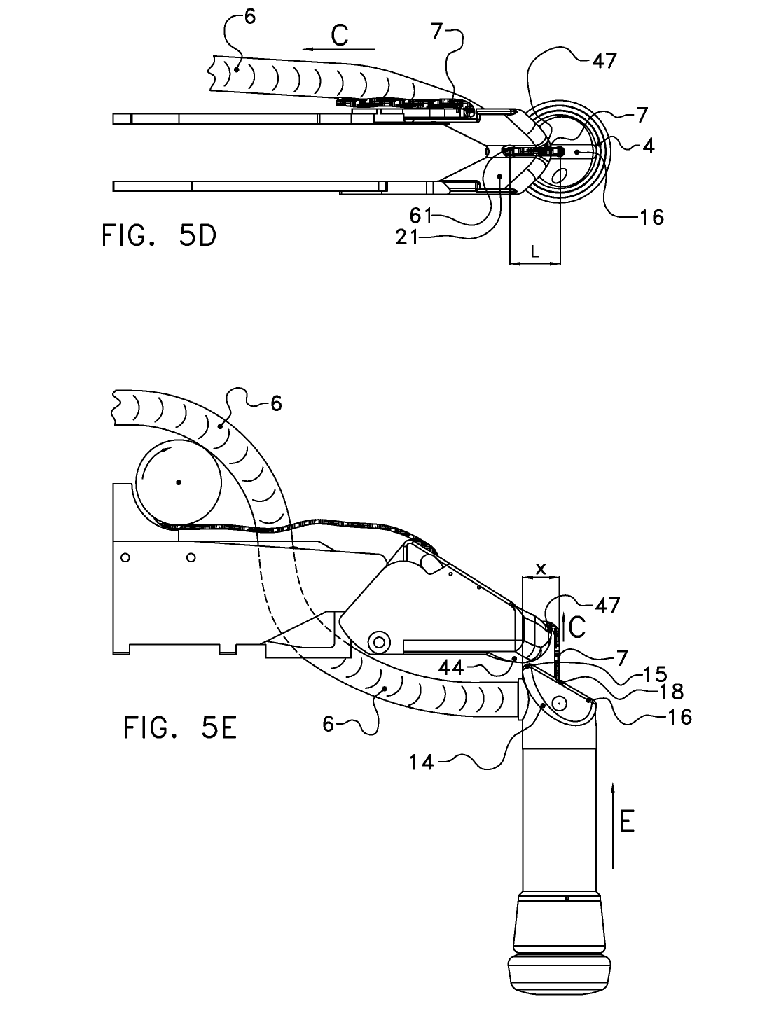

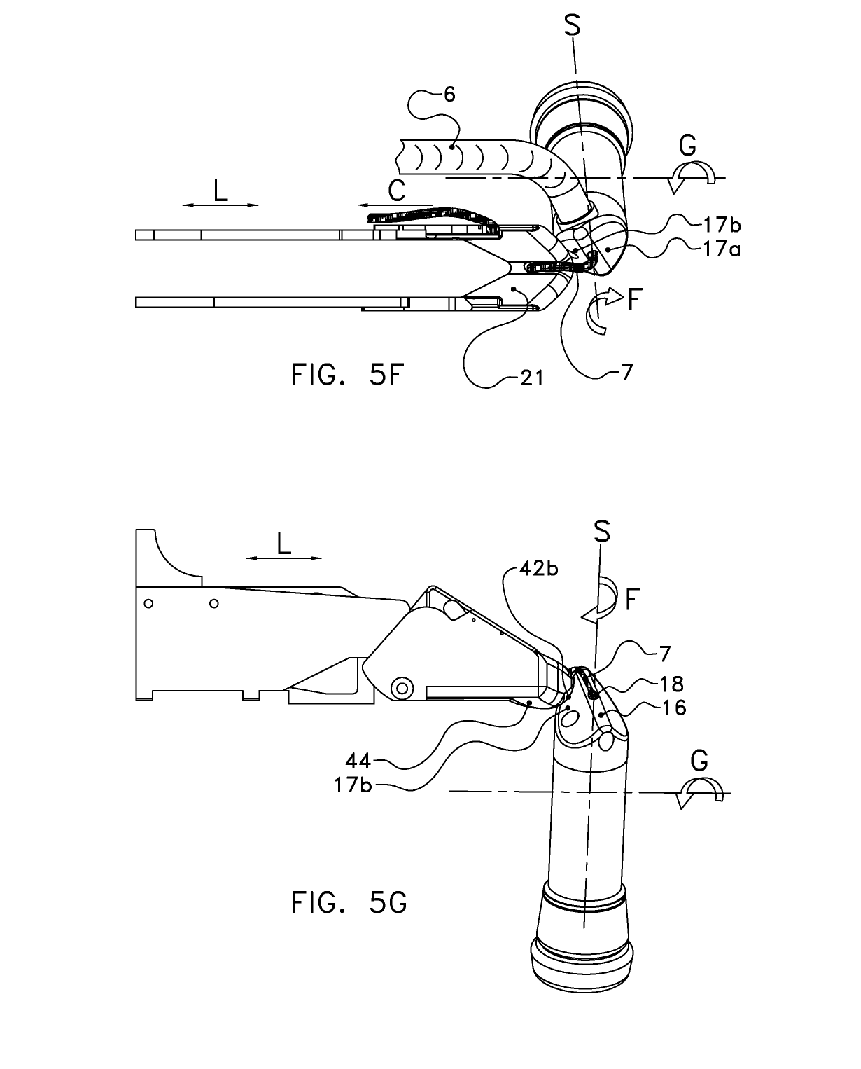

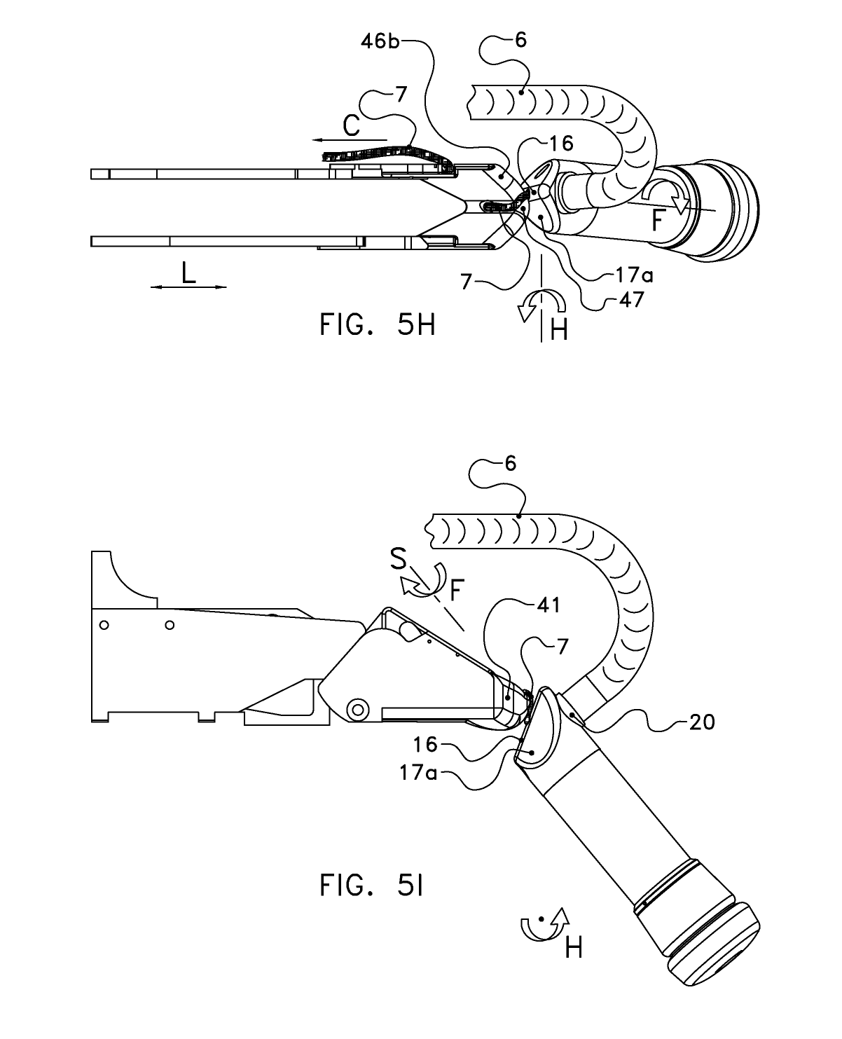

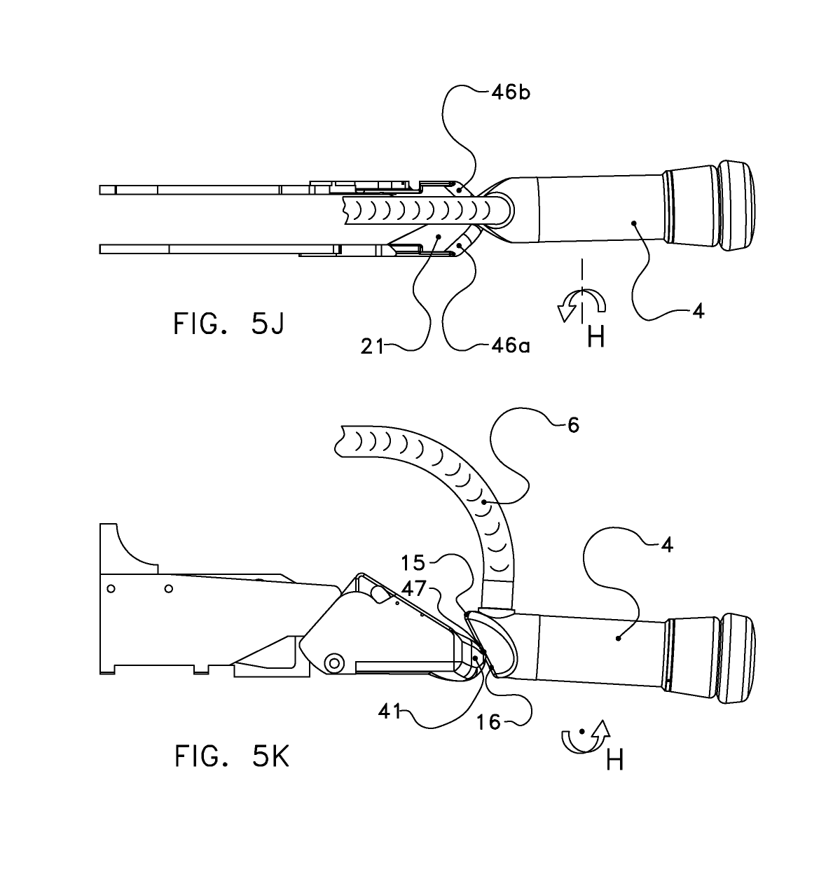

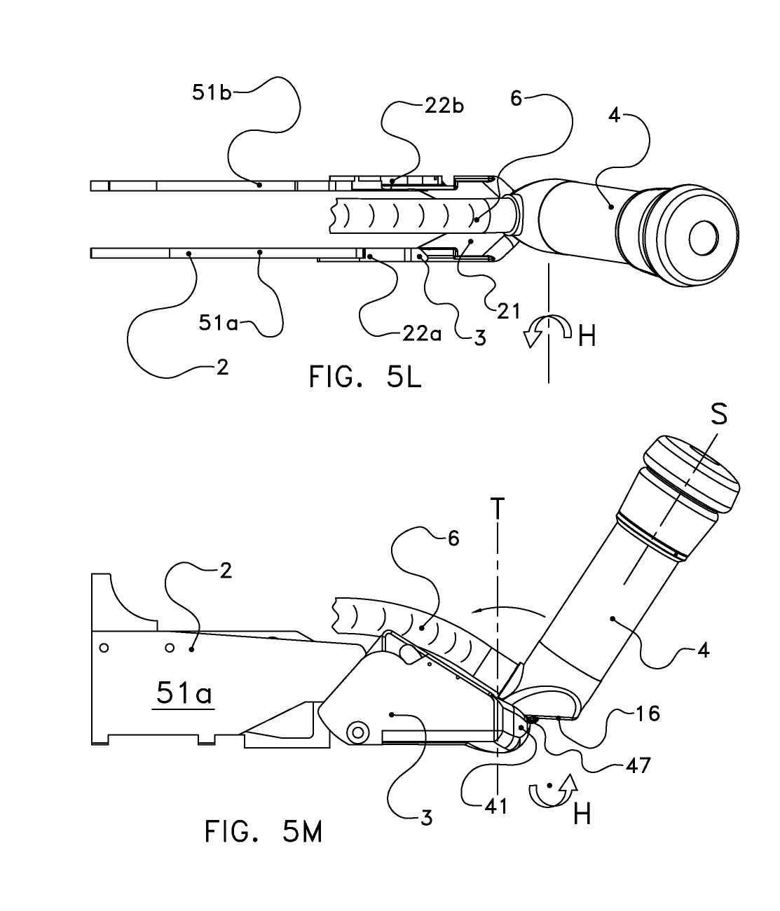

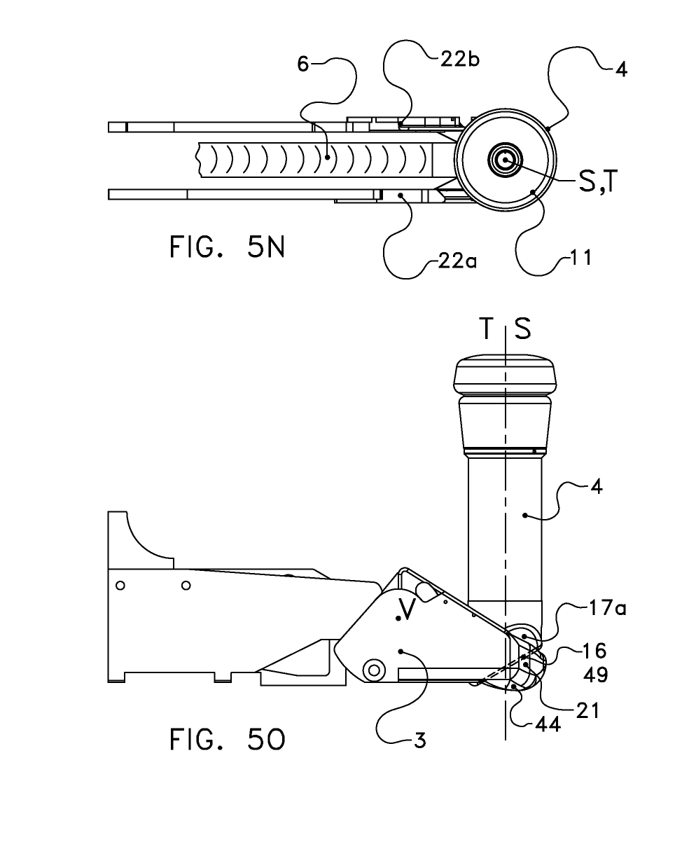

After the milking cups 4 have been fitted on the respective teats, milking can take place. When milking has finished, the milking cups are released in the usual manner from the teats and they fall on the floor 100, usually flat, as is illustrated in FIG. 5A. The air hole 19 will remain clear of dirt which is present on the floor, so that the discharge of milk is ensured, even during the next milking operation.

Thereafter, the reel 5 is operated in order to pull in the cord, during which the cord is tensioned. If the milking cup 4 is situated next to and under the arm 2, the cord will be able to extend over the side wall 22a, 22b. As a result of the sloping upper edges 45a, 45b, 46a, 46b, the cord will automatically move to the recess 47. This will also occur because the upper edge is at the smallest distance to the hole 61 at the location of the recess 47. The milking cup 4 will then arrive at the distal end of the holder 3 due to its upward movement (E), and will be suspended upside down, see FIGS. 5B (top view) and 5C. As the hose 6 will extend next to the arm, the milking cup may be positioned slightly obliquely (not shown here) with respect to a vertical plane which contains the longitudinal direction L.

Upon some further pulling on the cord 7, the point of the milking cup 4 which is highest at that moment and is formed by the rounded and pointed end 15, will touch the outer surface of the holder 3, usually surface 44 of the bottom 40 (FIGS. 5D and 5E). If the point 15 does not already immediately slip away across the outer surface of the holder 3 upon further pulling of the cord 7, a torque will be exerted on the milking cup 4 due to the abovementioned distance x between point 15 and the point of engagement 18, as a result of which it will rotate until the direction of the cup axis S is inclined with respect to the surface of the holder to such a degree that the point 15 slides or another surface of the contact part 14 makes contact with the outer surface of the holder.

The inclined shape of the outer surface 44, together with the pointed end 15, will assist in tilting the milking cup 4 in a vertical plane and in rotating it about the cup axis, depending on the actual position of the milking cup 4 when it comes into contact with the holder 3. In FIGS. 5F and 5G, on that side where the hose 6 comes up, the point 15 has slid away across the outer surface 44 and the inclined surface 17b has come into sliding contact with the outer surface 44. The milking cup 4 is, inter alia, subjected to an upward tilting movement (G) about an axis parallel to the longitudinal direction and a rotation (F) about axis S. The contact between the convex outer surface 44 and the flat surface 17b assists said movements.

Eventually, the edge 16 may come into contact with the outer surface 44, see FIGS. 5H and 5I. There may then be an upward tilting movement (H) of the milking cup in a vertical plane which contains the longitudinal direction L, in which the tilting point is the (moving) point of contact between the straight edge 16 and the convex outer surface 44.

When pulling on the cord 7 is continued, the edge 16 can swing over and around the upper edge 46b (H; FIGS. 5J and 5K), following which the inclined surfaces 17a, 17b come into contact with the surfaces 48a, 48b and the milking cup, with regard to the orientation with respect to the axes S and T, is directed into a unique position (FIGS. 5K and 5O), in which the connection 20 and the hose 6 are directed in the longitudinal direction L, in the proximal direction. The hole 18 is just above the hole 61 and in line therewith, with the axes S and T coinciding.

The contact part 14 is situated below the level of the pivot axis V. The hose connection 20 is also in a relatively low position. The hose 6 can extend inside the holder and the arm 2 without a twist or sharp bend in the duct-shaped or trough-shaped space defined by the side walls 22a, 22b and 51a, 51b and the bottom 52. The hose 6 can in this case remain below the pivot axis V.

In order to move the milking cup 4 to a storage position, in which cleaning can take place, if necessary, pulling on the cord 7 by reel 5 is continued, if desired without interruption, that is to say without ceasing to pull when the position of FIG. 5O is reached. The cord 7 will then, counter to the force of the spring 70, cause the holder 3 to rotate about one single pivot axis V, in the direction A, from the position of FIG. 6A (corresponding to that of FIG. 5O), via the position of FIG. 6B, to the storage position of FIG. 6C. All this is illustrated for one side of the pivot 8, but the process of rotation is similar for the other side.

The circular strips 54, 58 are displaced inside the circular grooves, rotating about the pivot axis V, until the stop 26 and the stop 34, respectively, abut the side walls 51a, 51b and the axis S, T is virtually horizontal, parallel to the longitudinal direction L. The recesses in the bottoms 40 and 52 provide space, if necessary, for a bend of the hose 6. The cord 7 can be fixed in the reel 5, so that the position of FIG. 6C is locked. After cleaning, the cord 7 can be released, following which the holder, on account of the spring 70, tilts back to the position in FIGS. 5O and 6A in which the end stops 25 and 35 rest against the underside of the rest of the arm 2 and the ends 56, 59 of the circular strips 54, 58 rest against the ends 29, 33 of the circular grooves 28, 32 and the device is ready for a subsequent milking operation.

It should be noted that the storage position of the milking cup can also be designed in such a manner, by means of the position of said stops, that the cup axis is at an angle with respect to the longitudinal direction L, smaller than +or −45 degrees with respect thereto.

Thus, the invention has been described by reference to certain embodiments discussed above. It will be recognized that these embodiments are susceptible to various modifications and alternative forms well known to those of skill in the art. Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A milking device comprising a carrier with a holder for at least one milking cup, the milking cup being connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein an upper section of the milking cup is provided with an opening for receiving a teat, wherein the milking cup, in a bottom section, engages with the hauling-in member at a first location, and wherein the bottom section is formed by an end body having a downwardly projecting contact part, a bottom end which extends next to and below the first location.

2. The milking device according to claim 1, wherein the contact part is eccentric with respect to the cup axis.

3. The milking device according to claim 1, wherein the first location coincides with the cup axis.

4. The milking device according to claim 1, wherein the hauling-in member is separate from the discharge line and the contact part is provided with a connection for the discharge line.

5. The milking device according to claim 4, wherein the discharge line is situated on the same side of the cup axis as the bottom end of the contact part and coincides with the bottom end in the same radial plane which contains the cup axis.

6. The milking device according to claim 5, wherein an axis of the connection and the bottom end of the contact part and the cup axis are in one plane, wherein the connection and the bottom end of the contact part are situated on the same side of the cup axis.

7. The milking device according to claim 4, wherein the milking cup comprises a cylinder sleeve between the upper and the lower section of the milking cup and the end body has a side surface which is substantially in line with the sleeve and to which the connection leads.

8. The milking device according to claim 1, wherein the bottom end of the contact part is rounded and pointed.

9. The milking device according to claim 1, wherein the contact part, in a side view of the milking cup, is formed asymmetrically with respect to the cup axis.

10. The milking device according to claim 1, wherein the bottom end of the contact part is situated on the peripheral edge of the milking cup, viewed in a plane of projection at right angles to the cup axis.

11. The milking device according to claim 1, wherein the contact part has a non-round cross section along planes at right angles to the cup axis.

12. The milking device according to claim 11, wherein the non-round cross section is symmetrical with respect to a first plane which comprises the cup axis and an axis of the connection and is asymmetrical with respect to a second plane which comprises the cup axis and is at right angles to the first plane.

13. The milking device according to claim 1, wherein the contact part comprises a substantially oblique conical section, and wherein the top of the oblique conical shape forms the bottom end of the contact part.

14. The milking device according to claim 1, wherein the contact part forms an edge which intersects the cup axis at an angle, wherein the edge is convex when viewed in a plane which contains the cup axis and the edge, wherein, on either side of the edge, bottom surfaces are formed which are inclined from the edge, and wherein the inclined bottom surfaces extend up to the periphery of the milking cup.

15. The milking device according to claim 1, wherein, at a second location, the contact part is provided with an air hole which is connected to the discharge line, wherein the second location is situated at a distance from the peripheral edge of the end body.

16. The milking device according to claim 15, wherein the air hole is situated in one of the inclined bottom surfaces.

17. The milking device according to claim 16, wherein the air hole is situated on a surface which is inclined with respect to the cup axis.

18. The milking device according to claim 17, wherein the air hole is situated in a location which is set back radially with respect to the sleeve.

19. A milking device comprising a carrier with a holder for at least one milking cup, the milking cup being connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein an upper section of the milking cup is provided with an opening for receiving a teat, wherein a lower section of the milking cup, viewed in side view, is shaped asymmetrically with respect to the cup axis, wherein the seating has a reference line which coincides with the cup axis when the milking cup rests in the seating and the seating of the holder is delimited by a seating wall, which is shaped asymmetrically on the inner side, viewed along a cross-sectional plane parallel to the plane of side view, with respect to the reference line for fittingly accommodating the contact part of the end body.

20. The milking device according to claim 19, wherein the carrier is at least one of portable and moveable.

21. The milking device according to claim 20, wherein the seating wall has an upper edge with a recessed passage for the hauling-in member.

22. The milking device according to claim 21, wherein the seating has a reference line which coincides with the cup axis when the milking cup rests in the seating, wherein the upper edge has first edge sections which are inclined towards one another with respect to a reference plane which is at right angles to the reference line towards a lowered second edge section which contains the passage.

23. The milking device according to claim 22, wherein the first and second edge sections are convex in cross section.

24. The milking device according to claim 21, wherein the holder is situated on the end of a carrier arm of the carrier, which carrier arm has a main direction, wherein the seating wall has seating side walls and a distal end wall connecting these side walls to one another.

25. The milking device according to claim 24, wherein first and second edge sections of the upper edge of the seating wall are situated in the end wall.

26. The milking device according to claim 24, wherein the second edge section is situated in the centre thereof.

27. The milking device according to claim 25, wherein, viewed in projection on the reference plane, the distal end wall is essentially U-shaped or V-shaped.

28. The milking device according to claim 25, wherein the top of the U shape or V shape is convex.

29. The milking device according to claim 25, wherein the seating side walls form third edge sections which adjoin the second edge sections and run in a distal direction.

30. The milking device according to claim 25, wherein the seating wall is interrupted in a proximal direction in order to form a passage for the discharge line.

31. The milking device according to claim 29, wherein the carrier arm forms a duct adjoining the passage.

32. The milking device according to claim 25, wherein the outer surface of the end wall, viewed in a cross-sectional plane at right angles to the reference plane, is convex.

33. The milking device according to claim 25, wherein the seating has a bottom wall, which, viewed in a cross-sectional plane transversely to the main direction, forms an outer surface which is inclined towards a lowest point, and/or, viewed in a cross-sectional plane parallel to the main direction and transversely to the reference plane, forms an outer surface which is inclined towards a lowest point.

34. The milking device according to claim 32, herein the outer surface is convex.

35. The milking device according to claim 25, wherein the seating has a bottom wall, which is provided with a passage for the hauling-in member.

36. The milking device according to claim 34, wherein the seating side wall with the upper edge has a section or location which has a smallest distance to the passage compared to the adjoining sections of the upper edge on either side.

37. The milking device according to claim 35, wherein the section intersects a vertical centre plane of the holder.

38. The milking device according to claim 35, wherein the bottom wall and/or the seating side wall is provided with a duct for guiding the hauling-in member from the passage to a proximal location.

39. The milking device according to claim 32, wherein the seating has an inner surface with a hole for the passage of the hauling-in member, wherein the inner surface comprises a section which is situated lower than the hole.

40. The milking device according to claim 38, wherein the seating wall is interrupted in one direction, for forming a passage for the discharge line.

41. The milking device according to claim 39, wherein the seating is delimited in the horizontal direction only towards two opposite lateral directions and in a direction transversely thereto, away from the carrier.

42. The milking device according to claim 40, wherein the seating wall is interrupted in a direction towards the carrier.

43. The milking device according to claim 32, wherein the carrier comprises a carrier arm, on the distal end of which the holder is arranged, wherein the carrier arm extends along a main direction (L), wherein the holder is connected to the carrier arm by a single pivot and is rotatable about a pivot axis (V) thereof in an upward and proximal direction from a receiving position of the holder in which the milking cup is vertical in the standby position to a storage position.

44. The milking device according to claim 42, wherein the storage position is in which the cup axis is at an angle to the main direction in a range from less than 45 degrees to essentially parallel to the main direction.

45. The milking device according to claim 42, wherein the storage position of the milking cup is tilted in the proximal direction, in which the single pivot is situated on the proximal end of the holder.

46. The milking device according to claim 42, wherein the storage position is one in which the cup axis extends essentially parallel to the main direction.

47. The milking device according to claim 42, wherein the milking cup extends, in the standby position in which it is accommodated in the holder, to below a horizontal plane which contains the pivot axis.

48. The milking device according to claim 46, wherein the lower section of the milking cup is provided with a lateral connection for the discharge line, and the shape of the seating of the holder and the lower section of the milking cup are adapted to one another in order to ensure that the connection is situated at least substantially below the pivot axis (V) in the standby position of the milking cup.

49. The milking device according to claim 42, wherein the holder and the carrier arm form a duct for the discharge line, wherein the duct is delimited by side walls, wherein the pivot is formed in both side walls by side wall sections which form partial pivots, the pivot axes of which are in line with one another.

50. The milking device according to claim 48, wherein each partial pivot in the respective side wall comprises a central pivot plate part with a circular edge section, as well as a cavity with a bearing edge therefor which is of complementary shape.

51. The milking device according to claim 49, wherein the bearing edge is formed on a circularly curved strip, and the edge section of the pivot plate part forms the radial inner edge of a circular guide groove for the strip.

52. The milking device according to claim 49, wherein the central pivot plate parts are integrally formed with the holder.

53. The milking device according to claim 42, wherein the hauling-in member is connected to a drive mechanism for exerting a tensile force on the hauling-in member for rotating the holder about the pivot axis in order to bring the milking cup from the standby position into said storage position.

54. The milking device according to 20, wherein the milking cup and the holder, respectively, are provided with first and second alignments that interact with one another for aligning the orientation of the milking cup with respect to its cup axis.

55. A milking device comprising a carrier with a holder for at least one milking cup, wherein the milking cup is connected to a discharge line and provided with a cup axis, wherein the holder forms a seating for keeping the milking cup in a standby position in a removable manner, wherein the milking cup is attached to an elongate flexible hauling-in member for pulling the milking cup towards and onto the seating after a milking operation, wherein a bottom end of the milking cup is formed asymmetrically, viewed in side view, with respect to the cup axis in order to form a first alignment, wherein the seating has a reference line which coincides with the cup axis when the milking cup rests in the seating, and the seating of the holder is delimited by a seating wall, which is formed asymmetrically on the inner side, viewed along a cross-sectional plane parallel to the plane of the side view, with respect to the reference line for fittingly accommodating and uniquely orientating the bottom end of the milking cup with respect to the cup axis in order to form a second alignment.

56. The milking device according to claim 54, wherein the milking cup is provided with a through-passage for the hauling-in member, which passage has a first end and a second end, wherein the hauling-in member enters the passage at a first end and is fixed in a second end.

57. The milking device according to claim 55, wherein the hauling-in member is fixed in a hauling-in direction in the second end of the passage and is free in the opposite direction.

58. The milking device according to claim 55, wherein the hauling-in member is folded onto itself in the second end of the passage.
